(19) United States
(12) Patent Application Publication
(10) Pub. No.: US 2019/0060041 A1
(43) Pub. Date: Feb. 28, 2019

(54) BRACKET-TYPE TOOTH CLEANER

(71) Applicant: ShenZhen Sure-Power Electrical Co. Ltd, Shenzhen (CN)

(72) Inventors: Guangrong Song, Shenzhen (CN); Jiahao Song, Shenzhen (CN); Jiawei Song, Shenzhen (CN); Wanzhen Song, Shenzhen (CN)

(21) Appl. No.: 16/021,095

(22) Filed: Jun. 28, 2018

(30) Foreign Application Priority Data
Aug. 31, 2017 (CN) 201721121228.1

(51) Int. Cl. A61C 17/34; A46B 9/04; A46B 9/02

(52) U.S. Cl. CPC A61C 17/3481; A46B 9/045; A61C 3/06; A46B 9/028; A46B 9/026

(57) ABSTRACT

A bracket-type tooth cleaner comprises a dental sleeve with bristles, a vibrating frame embedded in the dental sleeve, a motor and a housing for accommodating the motor; a spindle of the motor is fixedly connected to the vibrating frame, so that the vibrating frame drives the dental sleeve to vibrate. The advantage of the bracket-type tooth cleaner is that:

the motor drives the vibrating frame to vibrate to cause the vibration of the dental sleeve, and the bristles on the surface of the dental sleeve clean the teeth. Since the shape of the dental sleeve is the same as the shape of the teeth, the tooth cleaner could clean teeth without dead angles; the motor drives the bristles on the surface of the dental sleeve to vibrate at a high speed, so the gaps between teeth could be effectively cleaned. The structure of the tooth cleaner is simple.

### CROSS REFERENCE TO RELATED APPLICATION

This application claims priority of Chinese patent application No. 201721121228.1 filed on Aug. 31, 2017. The contents of the above application are all hereby incorporated by reference.

### TECHNICAL FIELD

The present application relates to the technology field of tooth cleaner, and more particularly, to a bracket-type tooth cleaner.

### BACKGROUND

With the improvement of people's living standard, people pay more and more attention to the whitening and health problems of teeth. Cleaning teeth is not only beneficial to the health of teeth, but also beneficial to the whitening of teeth. Nowadays, people mainly use toothbrush to clean teeth. The toothbrush could achieve a certain cleaning effect to the teeth, but there are dead angles when cleaning teeth with toothbrush and the teeth could not be completely cleaned; meanwhile, it is difficult for the existing toothbrush to clean the tiny gap between teeth.

### SUMMARY

To solve the defect of the prior art, the embodiments of the present application provide a bracket-type tooth cleaner.

The solution of the embodiments of the present application is:

A bracket-type tooth cleaner comprises a dental sleeve with bristles, a vibrating frame embedded in the dental sleeve, a motor and a housing for accommodating the motor; a spindle of the motor is fixedly connected to the vibrating frame, so that the vibrating frame drives the dental sleeve to vibrate.

Preferably, the racket-type tooth cleaner further comprises an euphotic cover, a power control board and a light emitting lamp disposed on the power control board; the power control board is disposed in the housing, and the euphotic cover is fixed between the lower end of the dental sleeve and the housing, and the light emitted by the light emitting lamp is transmitted through the euphotic cover into the dental sleeve.

Preferably, a battery is disposed in the housing, and the battery is electronically connected to the power control board.

Preferably, the vibrating frame comprises an inner vibrating strip and an outer vibrating strip parallel to each other, and the shape of the inner vibrating strip and the outer vibrating strip is respectively same as the shape of the dental sleeve.

Preferably, the vibrating frame is made of fireproof PC material.

Preferably, a waterproof sleeve is sleeved on the housing.

Preferably, the dental sleeve is a silicone dental sleeve, and the housing comprises an upper housing and a lower housing that engages with the upper housing.

According to the above technical solutions, the embodiments of the present application may have the following beneficial effects: the motor drives the vibrating frame to vibrate to cause the vibration of the dental sleeve, and the bristles on the surface of the dental sleeve clean the teeth. Since the shape of the dental sleeve is the same as the shape of the teeth, the tooth cleaner could clean teeth without dead angles; the motor drives the bristles on the surface of the dental sleeve to vibrate at a high speed, so the gaps between teeth could be effectively cleaned. The structure of the tooth cleaner is simple and it is easy to use the tooth cleaner to clean teeth.

The above description is only the overview of the technical solutions of the present application. In order to more fully understand the technical features of the present application and implement the present application in accordance with the content of the specification, and in order that the above and other objects, features and advantages of the present application could be more obvious and more understandable, the following preferred embodiments with the accompanying drawings are described in detail as follows.

### BRIEF DESCRIPTION OF THE DRAWINGS

FIG. 1 is an exploded view of the embodiment of the present application;

FIG. 2 is a space diagram of the vibrating frame of the embodiment of the present application.

### DETAILED DESCRIPTION

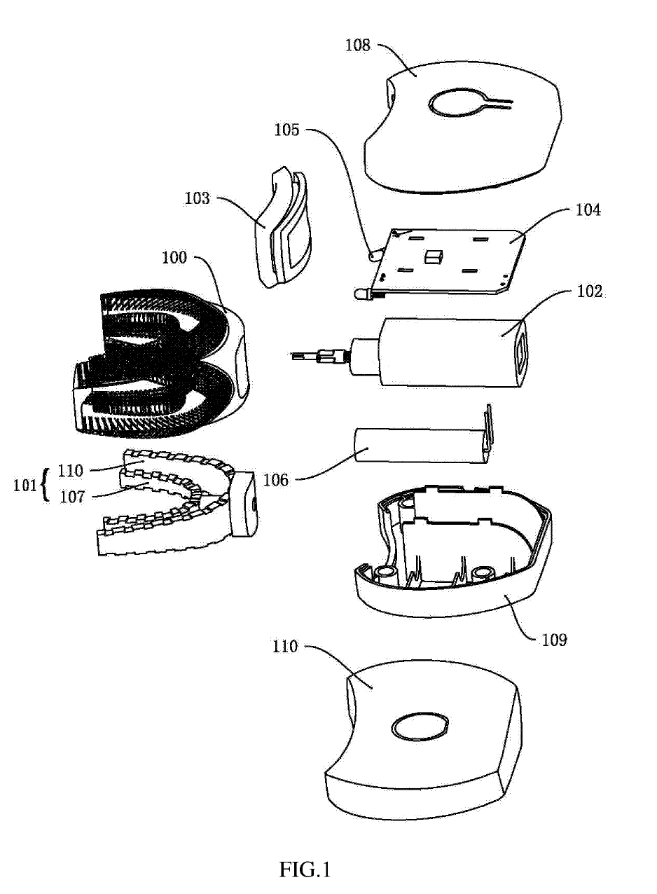

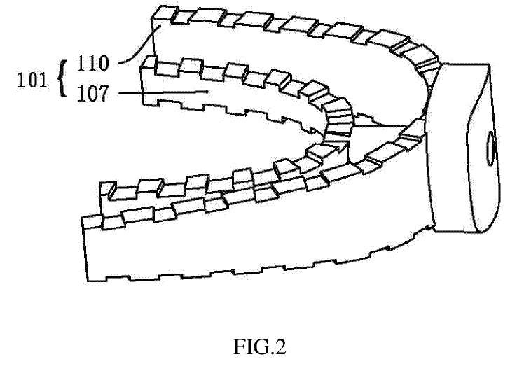

As shown in FIG. 1 and FIG. 2, a bracket-type tooth cleaner comprises a dental sleeve 100 with bristles, a vibrating frame 101 embedded in the dental sleeve 100, a motor 102 and a housing for accommodating the motor 102; a spindle of the motor 102 is fixedly connected to the vibrating frame 101, so that the vibrating frame 101 drives the dental sleeve 100 to vibrate. The motor 102 drives the vibrating frame 101 to vibrate to cause the vibration of the dental sleeve 100, and the bristles on the surface of the dental sleeve 100 clean the teeth. Since the shape of the dental sleeve 100 is the same as the shape of the teeth, the tooth cleaner could clean teeth without dead angles; the motor 102 drives the bristles on the surface of the dental sleeve 100 to vibrate at a high speed, so the gaps between teeth could be effectively cleaned.

As shown in FIG. 1 and FIG. 2, the bracket-type tooth cleaner further comprises an euphotic cover 103, a power control board 104, and a light emitting lamp 105 disposed on the power control board 104. The power control board 104 is disposed in the housing, and the euphotic cover 103 is fixed between the lower end of the dental sleeve 100 and the housing, and the light emitted by the light emitting lamp 105 is transmitted through the euphotic cover 103 into the dental sleeve 100. The light generated by the light emitting lamp 105 helps to decompose the dirt on the surface of teeth, which is favorable to clean the teeth.

As shown in FIG. 1 and FIG. 2, a battery 106 is disposed in the housing, and the battery 106 is electronically connected to the power control board 104. The battery 106 provides power for the motor 102 and the light emitting lamp 105.

As shown in FIG. 1 and FIG. 2, the vibrating frame 101 comprises an inner vibrating strip 107 and an outer vibrating strip 110 parallel to each other, and the shape of the inner vibrating strip 107 and the outer vibrating strip 110 is respectively same as the shape of the dental sleeve 100. The inner vibrating strip 107 and the outer vibrating strip 110 simultaneously vibrates, to make the bristles on the surface of the dental sleeve 100 steadily vibrate. Wherein, the vibrating frame 101 is made of fireproof PC material.

As shown in FIG. 1 and FIG. 2, a waterproof sleeve 110 is sleeved on the housing, and the waterproof sleeve 110 could prevent water from entering the housing, effectively preventing the influence of water to the power control board 104 in the housing. The dental sleeve 100 is a silicone dental sleeve 100, and the housing comprises an upper housing 108 and a lower housing 109 that engages with the upper housing 108. The surface of the upper housing 108 is provided with a switch for controlling the motor.

The above are the embodiments of the present application. It should be pointed out that for the person skilled in the art, a number of improvements and modifications made without departing from the principle of the present application should be considered to fall into the protection scope of the present application.

What is claimed is:

1. A bracket-type tooth cleaner comprises a dental sleeve with bristles, a vibrating frame embedded in the dental sleeve, a motor and a housing for accommodating the motor; a spindle of the motor is fixedly connected to the vibrating frame, so that the vibrating frame drives the dental sleeve to vibrate.

2. The bracket-type tooth cleaner according to claim 1, wherein the racket-type tooth cleaner further comprises an euphotic cover, a power control board and a light emitting lamp disposed on the power control board; the power control board is disposed in the housing, and the euphotic cover is fixed between the lower end of the dental sleeve and the housing, and the light emitted by the light emitting lamp is transmitted through the euphotic cover into the dental sleeve.

3. The bracket-type tooth cleaner according to claim 2, wherein a battery is disposed in the housing, and the battery is electronically connected to the power control board.

4. The bracket-type tooth cleaner according to claim 1, wherein the vibrating frame comprises an inner vibrating strip and an outer vibrating strip parallel to each other, and the shape of the inner vibrating strip and the outer vibrating strip is respectively same as the shape of the dental sleeve.

5. The bracket-type tooth cleaner according to claim 1, wherein the vibrating frame is made of fireproof PC material.

6. The bracket-type tooth cleaner according to claim 1, wherein a waterproof sleeve is sleeved on the housing.

7. The bracket-type tooth cleaner according to claim 1, wherein the dental sleeve is a silicone dental sleeve, and the housing comprises an upper housing and a lower housing that engages with the upper housing.

8. The bracket-type tooth cleaner according to claim 2, wherein the vibrating frame is made of fireproof PC material.

9. The bracket-type tooth cleaner according to claim 2, wherein a waterproof sleeve is sleeved on the housing.

10. The bracket-type tooth cleaner according to claim 2, wherein the dental sleeve is a silicone dental sleeve, and the housing comprises an upper housing and a lower housing that engages with the upper housing.

11. The bracket-type tooth cleaner according to claim 3, wherein the vibrating frame is made of fireproof PC material.

12. The bracket-type tooth cleaner according to claim 3, wherein a waterproof sleeve is sleeved on the housing.

13. The bracket-type tooth cleaner according to claim 3, wherein the dental sleeve is a silicone dental sleeve, and the housing comprises an upper housing and a lower housing that engages with the upper housing.

14. The bracket-type tooth cleaner according to claim 4, wherein the vibrating frame is made of fireproof PC material.

15. The bracket-type tooth cleaner according to claim 4, wherein a waterproof sleeve is sleeved on the housing.

16. The bracket-type tooth cleaner according to claim 4, wherein the dental sleeve is a silicone dental sleeve, and the housing comprises an upper housing and a lower housing that engages with the upper housing.
